(19) United States
(12) Patent Application Publication
(10) Pub. No.: US 2011/0000548 A1
(43) Pub. Date: Jan. 6, 2011

(54) AIRFLOW SEPARATION INITIATOR

(76) Inventors: Bobby W. Sanders, Westlake, OH (US); Charlotte A. Sanders, Westlake, OH (US); Lois J. Weir, Akron, OH (US)

Correspondence Address: CALFEE HALTER & GRISWOLD, LLP, 800 SUPERIOR AVENUE, SUITE 1400, CLEVELAND, OH, 44114, US

(21) Appl. No.: 12/710,018

(22) Filed: Feb. 22, 2010

Related U.S. Application Data
(60) Provisional application No. 61/154,232, filed on Feb. 20, 2009.

(51) Int. Cl. F02K 1/78

(52) U.S. Cl. 137/1; 137/15.1

(57) ABSTRACT

A supersonic inlet includes a cowl and an innerbody. An airflow duct entrance, between the cowl and the centerbody, receives an incoming airflow. An airflow duct exit, between the cowl and the centerbody, delivers a subsonic airflow. A controlled airflow separation initiator, on the innerbody and upstream of a lip of the cowl, which, when actuated, creates a separation in the incoming airflow. The separation region changes the local flow field aerodynamics such that an airflow weight flow at the cowl lip matches an airflow weight flow at a duct minimum area, between the airflow duct entrance and the airflow duct exit.

This application claims the benefit of U.S. Provisional Application No. 61/154,232, filed Feb. 20, 2009, which is hereby incorporated by reference.

### BACKGROUND

The present invention relates to inlets for supersonic flow. It finds particular application in conjunction with air inlets for aircraft that are designed to fly at supersonic speeds and will be described with particular reference thereto. It will be appreciated, however, that the invention is also amenable to other applications.

The purpose of a supersonic inlet component of a propulsion system for high speed aircraft is to efficiently decelerate the approaching high speed airflow to speeds that are compatible with efficient turbojet engine operation and to provide optimum matching of inlet and engine airflow requirements. Entrance airflow speeds to existing airbreathing engines must typically be subsonic; therefore, it is necessary to decelerate the airflow speed during supersonic flight. Typically, engine entrance Mach number for supersonic propulsion systems is 0.2 to 0.4. The inlet must reduce the velocity of the approaching airflow from supersonic levels to these subsonic levels while maintaining a minimum of loss in free stream total pressure and while maintaining a near-uniform flow profile at the engine entrance.

In aircraft propulsion systems having supersonic inlets, the inlet diffuses the air in a manner to minimize the pressure losses, cowl and additive drag, and flow distortion. For supersonic inlets, efficient deceleration of the supersonic velocities is accomplished by a series of weak shock waves or isentropic compression, in which the supersonic free stream speed is progressively slowed to an inlet throat Mach number of about 1.30. A terminal shock wave is positioned at the throat of the inlet to further reduce the Mach 1.3 supersonic velocity of the airflow to a high subsonic level. The speed of the airflow is then additionally slowed in the subsonic diffuser of the inlet by a smooth transitioning of the airflow duct from the throat area to the larger area at the engine entrance.

Propulsion system inlets in which some of the supersonic compression or deceleration in velocity is accomplished external to the inlet cowling and some of the compression is accomplished internally are referred to as mixed-compression inlets. This type of inlet has commonly been proposed for high-speed aircraft that cruise at Mach numbers greater than 2.0. Optimum inlet performance is provided when the terminal shock position is maintained at the inlet throat station. However, mixed-compression inlets can suffer from an undesirable phenomenon known as inlet unstart. When the terminal shock is positioned near the inlet throat to obtain optimum performance, a small airflow disturbance, either internally or externally generated, can result an inlet unstart. The airflow disturbance causes the terminal shock to move forward of the inlet throat where it is unstable and is violently expelled ahead of the inlet cowling. This shock expulsion or unstart causes a large rapid variation in inlet supply airflow and pressure recovery, and thus a large thrust loss and drag increase. Inlet buzz, engine stall, and engine combustor blowout may also occur. Obviously, an inlet unstart is extremely undesirable for both the propulsion system and the aircraft.

An inlet can be designed to provide an increased operating margin before an inlet unstart by incorporating stability bleed controls as described in U.S. Pat. Nos. 3,799,475 and 6,920,890. These controls significantly increase the operating margin of safe inlet operation by providing a large variation in bleed airflow as the terminal shock changes position in the inlet. However, if inlet unstart does occur, typically large variations in inlet geometry are required to reestablish initial design operating conditions. The forces associated with unstart can cause mission abort or worse. The time that is required to restart the inlet with the typical inlet variable geometry system is larger than desired especially when the violent reactions to inlet unstarts are considered. Thus, it is desired to have a new, less complex, and improved mechanism incorporated into the inlet design that can effect a quick inlet restart. This type of system would be included in a design in which a stability bleed system for increased operability had been incorporated as well as in designs where their incorporation was not feasible.

The present invention provides a new and improved apparatus and method for inlet restart.

### SUMMARY

In one aspect of the present invention, it is contemplated a supersonic inlet includes a cowl and an innerbody. An airflow duct entrance, between the cowl and the centerbody, receives an incoming airflow. An airflow duct exit, between the cowl and the centerbody, delivers a subsonic airflow. A controlled airflow separation initiator, on the innerbody and upstream of a lip of the cowl, which, when actuated, creates a separation in the incoming airflow. The separation region changes the local flow field aerodynamics such that an airflow weight flow at the cowl lip matches an airflow weight flow at a duct minimum area, between the airflow duct entrance and the airflow duct exit.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates an isometric sketch of an axisymmetric, mixed-compression inlet for a supersonic propulsion system;

FIG. 2 illustrates a partial cut-away of the isometric sketch of FIG. 1 illustrating an axisymmetric, mixed-compression inlet for a supersonic propulsion system;

FIG. 3 illustrates an axial cross-section of a portion of the inlet illustrated in FIGS. 1 and 2;

FIG. 4 illustrates the axial cross-section of FIG. 3 showing an aerodynamic process of slowing of an airflow;

FIG. 5 illustrates a flow field in an inlet with a disturbance causing an inlet unstart;

FIG. 6 illustrates an inlet including an airflow separation actuator (a controlled airflow separation initiator) in accordance with one embodiment of the present invention;

FIG. 7 illustrates an inlet utilizing an airflow separation actuator during stable unstarted conditions in accordance with one embodiment of the present invention;

FIG. 8 illustrates an airflow-separation actuator door integrated into an axisymmetric high-speed inlet in accordance with one embodiment of the present invention;

FIG. 9 illustrates airflow-separation actuator doors in an axisymmetric inlet installation;

FIG. 10 illustrates airflow-separation actuator doors in an axisymmetric inlet installation;

FIG. 11 illustrates an airflow-separation actuator door in a closed (unactuated) position;

FIG. 12 illustrates an airflow-separation actuator door in an open (actuated) position;

FIG. 13 illustrates an airflow-separation actuator door in an embodiment of the present invention including a 2D supersonic inlet;

FIG. 14 illustrates an airflow-separation actuator door in a closed (unactuated) position;

FIG. 15 illustrates an airflow-separation actuator door in an open (actuated) position;

FIG. 16 illustrates an airflow separation actuator in another embodiment of the present invention;

FIG. 17 illustrates an airflow separation actuator in another embodiment of the present invention;

FIG. 18 illustrates an airflow separation actuator in another embodiment of the present invention;

FIG. 19 illustrates an airflow separation actuator in another embodiment of the present invention; and

FIG. 20 illustrates an airflow separation actuator in another embodiment of the present invention.

### DETAILED DESCRIPTION OF ILLUSTRATED EMBODIMENT

The present invention provides a design for a new airflow-separation actuator for a high-speed inlet of a supersonic propulsion system. This airflow-separation actuator, when integrated into the inlet design, offers the capability of effecting a quick restart of the inlet. As part of its overall operation characteristics, it can also be used to establish and maintain stable unstarted inlet operation. This simple and light weight mechanism may be actuated quickly (e.g., within less than about 1 second) and effects restart by causing spillage over the inlet cowling until the proper restart aerodynamic conditions are achieved. For inlet start/restart to occur, a proper combination of aerodynamic conditions (mass-flow, pressure, velocity) at an axial station just forward of the inlet cowl lip and conditions at the inlet throat station must be achieved. Engine airflow demand must also be set at inlet restart levels. One embodiment of the present invention offers a quick inlet restart with reduced system complexity and weight for mixed-compression inlets. It has application to most high-speed inlet systems for supersonic and hypersonic flight vehicles as well as high-speed cruise missiles.

This airflow-separation actuator can be used to enhance the operation of mixed-compression inlets, and offers a new approach for inlet designers. It offers quick restart capability, and if the engine airflow demand is below the level that will allow inlet restart, particularly at off-design conditions, the airflow separation actuator can be used to adjust the inlet aerodynamics such that stable unstarted (buzz free) operation is maintained.

Utilizing a system to create and control an airflow separation on the forward ramp of a mixed-compression inlet to effect quick restart provides an increase in safety. A quick restart capability improves safety because inlet unstart, if sustained for even a short length of time, can significantly affect the aircraft aerodynamics. Aerodynamic reports with descriptions of inlet unstarts on military aircraft such as the XB-70 and the SR-71 have indicated that the unstart caused a severe reaction of the aircraft. Typically, adverse aerodynamic influence on both the inlet and airframe during inlet unstart requires an integration of complex and heavy hydraulic systems into the overall aircraft design. These systems are required to maintain adequate control because of the large transient forces that are imposed by an inlet unstart. Obviously, the impact of inlet unstart on the aircraft must be reduced for a commercial aircraft. When unstart occurs, the inlet must be restarted quickly. Since the conventional approach to restart a mixed-compression inlet is to adjust the variable geometry (increase the inlet throat area) to achieve restart with a hydraulic actuation system, restart requires more time than is desirable. The airflow-separation actuator concept offers a means of rapid restart with a simple light weight system. The integration of this system into the inlet design and operation will allow a significant reduction in overall system weight, since it would reduce the large hydraulic requirement that would otherwise be required to maintain control of the aircraft. Therefore, the separation airflow controller of this invention, when integrated with a mixed-compression high-speed inlet offers a significant improvement over traditionally designed inlet systems. The airflow-separation actuator will enable the development of inlets and propulsion systems for high-speed aircraft that offer increased range and payload/profit.

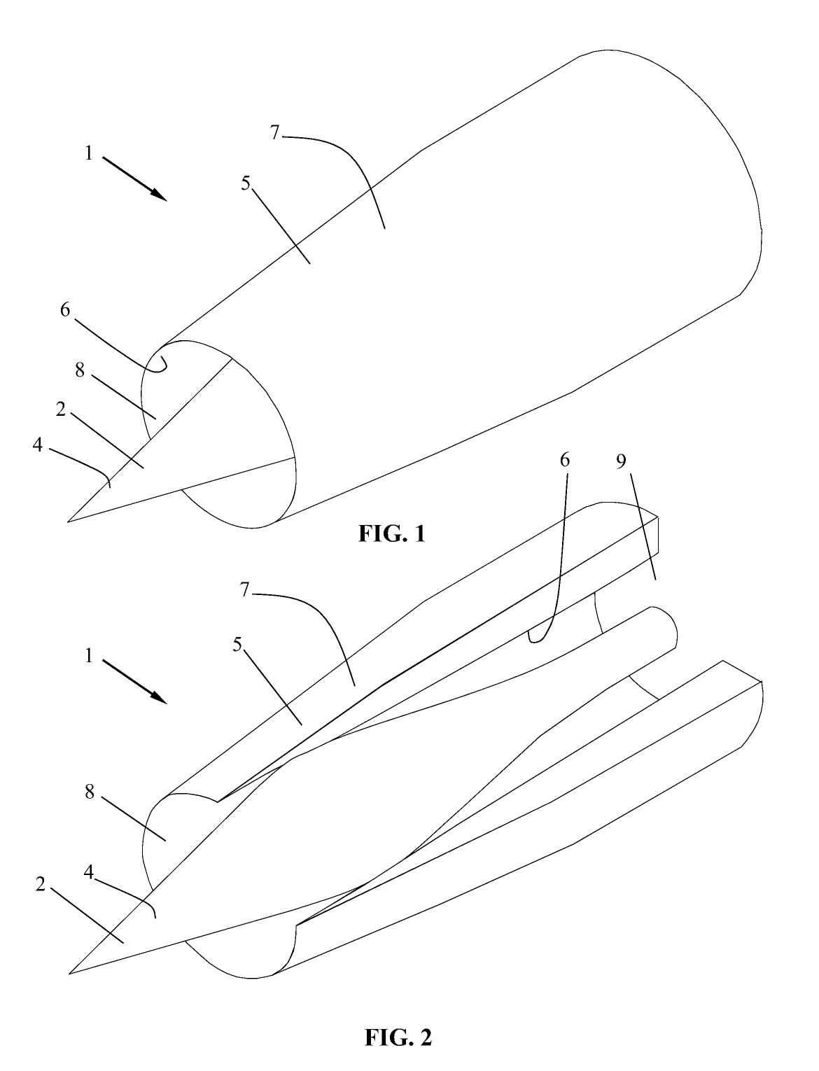

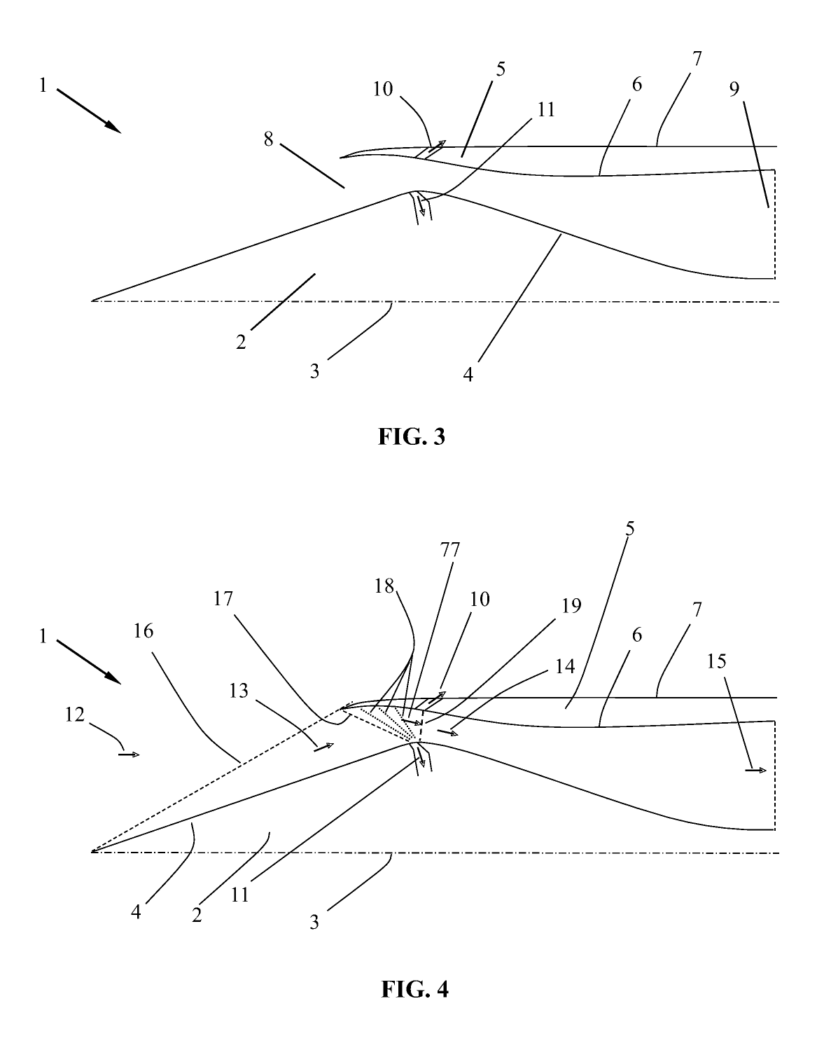

FIGS. 1 and 2 illustrate isometric sketches of an axisymmetric, mixed-compression inlet 1 for a supersonic propulsion system. A portion of a cowling 5 of the inlet 1 is cut away in FIG. 2 to allow a view of an innerbody 2 of the inlet 1. In the illustrated embodiment, the innerbody 2 is a centerbody having a substantially round cross-section. The inlet 1 includes the external cowling 5 having an internal surface 6 and an external surface 7. The centerbody 2 includes an axisymmetric shape with an external surface 4. These inlet components, centerbody 2 and cowl 5, define an axisymmetric airflow duct with an entrance 8 and an exit 9. A jet engine of the propulsion system is typically installed such that the airflow at the inlet downstream exit 9 enters the engine. An axial cross-section of a portion of the inlet 1 of FIGS. 1 and 2 is presented in FIG. 3 and includes a centerline 3 of the axisymmetric inlet 1. Throat bleed capability is also illustrated in the figure. As illustrated in FIG. 3, a cowl bleed 10 ducts low energy bleed airflow from the cowl inner surface 6 and exhaust this bleed overboard through the external surface 7 of the cowl 5. Centerbody 2 bleed 11 is removed from the centerbody surface 4 and is exhausted overboard. This bleed is typically ducted through centerbody support struts to an overboard exit.

A mixed-compression supersonic inlet utilizes a series of shock waves and a subsonic diffuser to slow the incoming high-speed airflow to the lower velocities required by a jet engine. This aerodynamic process of slowing of the airflow is illustrated in FIG. 4. The interaction of the free stream high-speed airflow 12 with the initial conical surface 4 of the centerbody 2 results in an oblique shock wave 16. This shock wave 16 slows the incoming airflow 12 to a lower supersonic velocity 13 and turns the airflow along the conical surface. The airflow 13 intercepts the internal surface 6 of the cowl 5 and a second oblique shock wave 17 is formed. This shock wave 17 continues to reduce the velocity of the airflow. A series of weak shock waves 18 is used to progressively reduce the duct supersonic Mach number of airflow 77 to about 1.3 so that minimum total pressure losses will result as the airflow 77 passes through the terminal shock wave 19. The terminal shock wave 19 reduces the supersonic velocity of the airflow 77 to airflow 14 at a high subsonic speed. The velocity of the airflow is then reduced to a low subsonic velocity airflow 15 that is required at the entrance of the jet engine. The subsonic diffuser provides a reduction in airflow velocity by providing an increase in duct cross-sectional area of inlet from the inlet throat (airflow 14) to the exit (airflow 15). The described inlet operation provides an airflow 15 with low losses in total pressure and low distortion to the engine of the propulsion system.

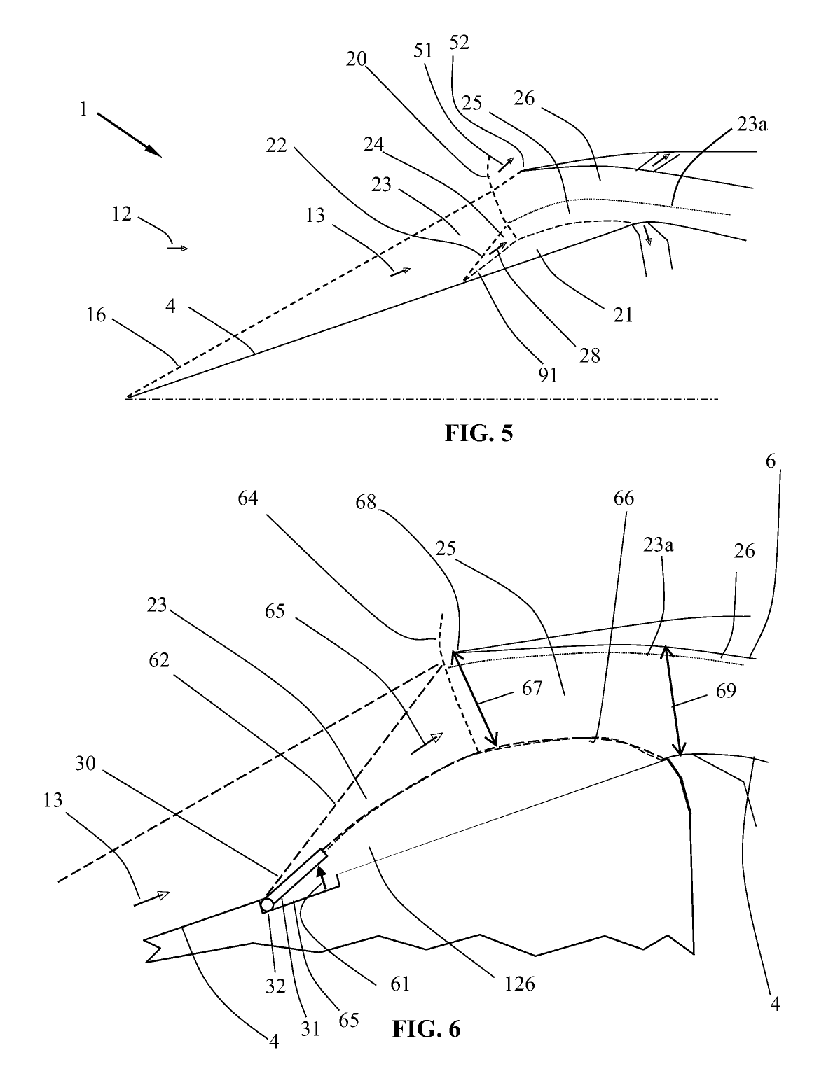

However, if a disturbance causes an inlet unstart, the flow field, as depicted in FIG. 5, may result. When unstart occurs the terminal shock wave 19 of FIG. 4 is rapidly expelled out of the inlet 1 to a new position 20 (see FIG. 5). This new position of the terminal shock wave 20 is a function of the approaching airflow 13 conditions on the centerbody 4 and the airflow 15 (see FIG. 4) demand at the engine entrance. The interaction of the airflow 13 with the terminal shock wave 20 results in the separation region 21 on the inner body surface 4 (see FIG. 5). Typically, the inlet will not naturally restart from this unstarted condition. At this new location the terminal shock 20 has a higher inflow Mach number 13 than does the inlet started throat terminal shock 19 of FIG. 4. At these higher local Mach conditions 13, and with no bleed for the terminal shock 20 intersection with the surface 4, the static pressure rise through the terminal shock causes a separation airflow region 21 to occur. This separation 21 significantly alters the illustrated inlet aerodynamics. The initial upstream part of the separation region 21 effectively acts as a wedge 91 or compression surface that interacts with the incoming airflow 13 to form an additional oblique shock 22. The part of the airflow 24 that passes through the shock wave 22 has a different velocity and pressure than the airflow 23 that did not experience the shock wave 22. These two different zones of airflow, airflows 23, 24 then pass through the terminal shock 20 with a resultant two different airflow streams 25, 26 downstream of the shock 20 with a slip streamline 23a defining the boundary between the airflow streams 25, 26. A larger loss in total pressure occurs for the airflow 26 than for the airflow 25 because the Mach number of the airflow approaching the terminal shock 20 is higher for the airflow 23 than for the airflow 24. Because of the large loss in total pressure through the terminal shock 20, particularly for the airflow 26, the inlet throat cannot pass all of the incoming airflow; therefore, the terminal shock 20 remains forward of the cowl 52 lip and allows excess airflow 51 to spill around the lip 52 to the outside air stream. The inlet 1 will remain unstarted until the aerodynamics of the inlet 1 are altered.

Typically, inlet restart is achieved by changing the geometry of the inlet. A geometry change is necessary to increase the ratio of the area of the duct at the inlet throat to the area of the duct at the cowl lip station. While the variable geometry approach works to restart the inlet, this approach generally requires the actuation of large, slow-moving surfaces. Inlet unstart imposes severe forces on the propulsion system and flight vehicle; therefore, the desire is to quickly restart and re-establish on-design and safe inlet operation.

Rapid restart can be achieved by using the airflow-separation actuator concept illustrated in the various embodiments of the present invention. With reference to FIG. 6, an airflow separation actuator 30 (a controlled airflow separation initiator) is illustrated in accordance with one embodiment of the present invention. In this embodiment, the airflow separation actuator 30 includes a barrier 31 (e.g., a flap or a door) on the centerbody surface 4. In one embodiment, a hinge 32 allows rotation 61 of the barrier 31 into the incoming airflow 13. Although the illustrated embodiment shows the barrier 31 at an angle which is not normal to the incoming airflow 13 or the surface 4, other embodiments in which the barrier is normal to the incoming airflow 13 or the surface 4 are also contemplated. For example, the barrier may extend out of (and then retract into) the surface 4 without the use of a hinge. Details of the airflow-separation actuator 30 and its installation into the inlet are discussed in FIGS. 6-16.

As shown in FIG. 6, the upstream surface of the airflow-separation actuator door 31 creates a compression surface to the incoming airflow 13. The interaction of the airflow 13 with the door 31 creates a controlled separation (and a separated region 126) that changes local flow field aerodynamics in the local airflow 13 and results in an oblique shock wave 62. In one embodiment, the oblique shock wave 62 emanates from a leading edge of a boundary 66 between the regions 25, 126 and is upstream of the oblique shock wave 22 (see FIG. 5). Proper axial positioning of the airflow-separation actuator door 31 and adjustment of the angle 61 of the door 31 allows most of the airflow 13 to pass through the oblique shock 62 and then terminal shock 64. The adjustment of the airflow-separation actuator door 31 of FIG. 6 provides a larger total pressure for the airflow 25 approaching the throat station than for the aerodynamic conditions of FIG. 5 as the airflow flows along a surface of the centerbody 2. In FIG. 5, a large part of the airflow passing through the inlet was in the lower pressure airflow region 26, with the remainder in the high pressure airflow region 25. Unlike the aerodynamics of FIG. 5, the aerodynamic configuration of FIG. 6 has a large part (e.g., a majority) of the airflow passing through the high pressure region of region 25 and only a very small portion of the flow passing through region 26. In one embodiment, a leading edge of the boundary 66 between the regions 25, 126 extends from a downstream edge of the door 31. The changes of pressure alone in the regions 25, 26 may be sufficient to pass all of the approach airflow 12 and allow the inlet to start. However, by controlling the size of the separation region 126, the effective airflow area ratio between the effective airflow area 67 at the cowl lip 68 and the airflow area 69 at the throat area (which is the duct minimum area 69 between the internal cowl surface 6 and the innerbody external surface 4) has also been changed. The increase in effective area ratio of throat area to incoming area also promotes inlet starting. The combination of effective area ratio increase and higher effective airflow total pressure will allow the inlet to start. In one embodiment, an airflow weight flow at the cowl lip 68 matches an airflow weight flow at the duct minimum area 69 when the controlled airflow separation initiator is actuated (e.g., when the door 31 extends into the incoming airflow 13). Of course, it is apparent to those who are skilled in the art that the inlet airflow supply and the downstream engine airflow demand must be at the proper level compatible for inlet starting.

With reference to FIG. 6, an effective area 67 between the boundary 66 and a lip 68 of the cowl is reduced by the size of the separation region 126 to achieve the airflow weight flow (amount of airflow) matching between the cowl lip effective area 67 and the throat area 69. In one embodiment, the cowl lip effective area 67 is less than or equal to the throat area 69.

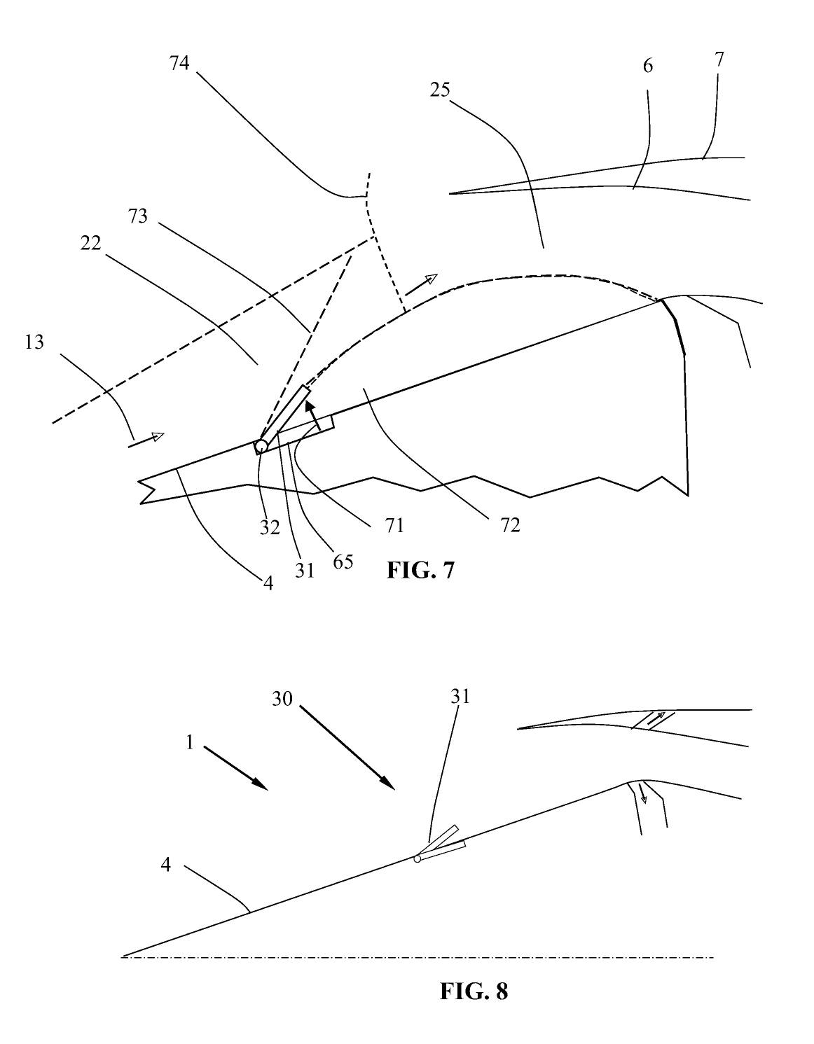

While the primary utilization of this invention relates to the restart of a high-speed inlet, a broadened use of the airflow-separation actuator can offer improvements in other regions of operation such as increased stable (buzz-free) range for unstarted inlet operation. In the flight envelope of the aircraft, particularly at off-design flight velocities, inlet operation at unstarted conditions may also be required. During flight at velocities other than the design flight velocity, a started inlet will often supply more airflow than the engine can handle; therefore, this airflow must be bypassed around the engine or the inlet be operated in an unstarted condition so that the excess airflow can be spilled around the cowl lip. In this flight regime, operation at buzz-free conditions is desired. Inlet buzz is characterized as a high frequency pulsing of the airflow within the inlet that can result in engine stall or failure of inlet structure. Since the requirement is to operate with the inlet unstarted, the desire is to provide a large buzz-free margin of stable operation. The utilization of the airflow separation actuator during stable unstarted conditions is illustrated in FIG. 7. With reference to FIG. 7, the terminal shock 74 is shown at a more upstream position than the terminal shock 64 illustrated in FIG. 6. This more upstream position is the result of the engine airflow demand being reduced to below the level that would allow started inlet operation. With reference again to FIG. 7, the stable unstarted shock 74 operating margin can be enhanced by the adjustment of the separated region 72 sized by controlling the airflow separation actuator door 31 position.

It will become apparent to those that are skilled in the art that the utilization of the airflow-separation actuator as described for the buzz free unstarted mixed-compression inlet operation would also benefit the operating characteristics of an external-compression inlet. The addition of an airflow-separation actuator at an appropriate location on the surface of the inlet upstream of the cowl lip would enhance the stable subcritical operating margin for this additional class of inlets.

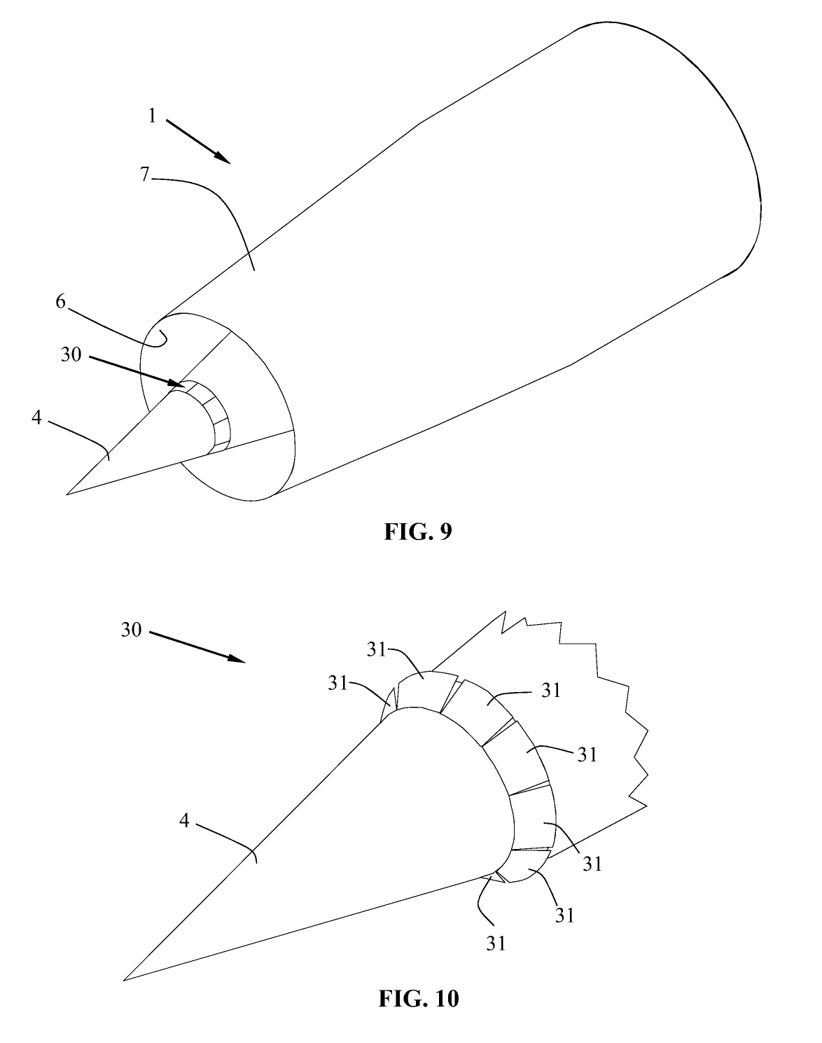

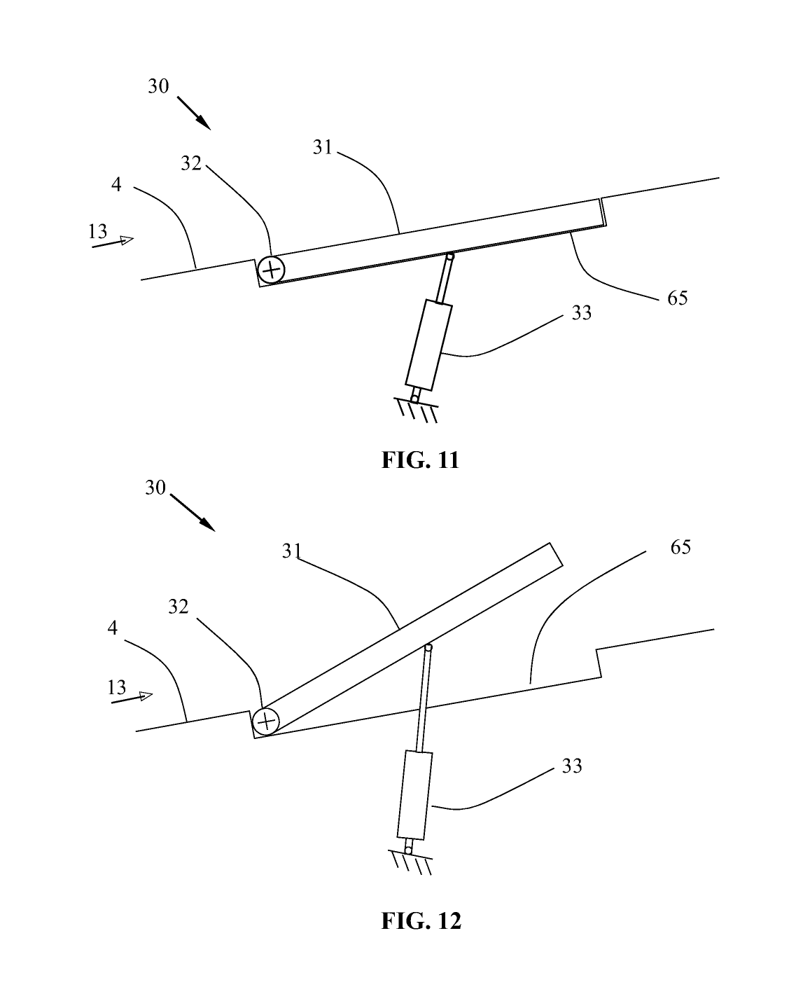

With reference to FIG. 8, the airflow-separation actuator doors 31 is integrated into an axisymmetric high-speed inlet 1. The airflow-separation actuator 30 is located in the surface 4 of the centerbody 2. The sizing, axial placement of the airflow-separation actuator 30, and the amount of required separation (effectively angle 61 of FIG. 6 or 71 of FIG. 7) for a particular inlet configuration may be determined by an experimental wind tunnel test program. For an axisymmetric inlet installation, the airflow-separation actuator door 30 would be placed as shown in FIGS. 9 and 10. The doors 31 are in a closed position for the started, on-design, inlet 1 operation in FIG. 9, and are shown actuated to a restart (open) position in FIG. 10. Details of the closed (e.g., unactuated) and open (e.g., actuated) airflow-separation actuator system 30 positions are presented in FIGS. 11 and 12, respectively. With reference to FIGS. 11 and 12, the airflow-separation actuator door 31 is located in a recessed cavity 65 in inlet surface 4. Door 31 is hinged 32 at the upstream end and is actuated by a mechanical (or electromechanical) actuator 33. The closed door 31 position of FIG. 11 is for normal started inlet operation when a disruption to the income airflow 12 is not desired. The actuated position of the door 31 in FIG. 12 is to effect inlet restart after inlet unstart has occurred. Since the restart door of the airflow-separation actuator system is small, simple and light weight when compared to state of the art inlet variable-geometry systems, a very rapid restart capability is provided. The response speed of the door 31 actuation will depend on sizing of the mechanical actuator 33; however, off-the-shelf hydraulic actuators are capable of providing the rapid movement (e.g., less than about 1 second) of light weight systems like the actuated door 31 of the airflow-separation actuator 30 of this invention.

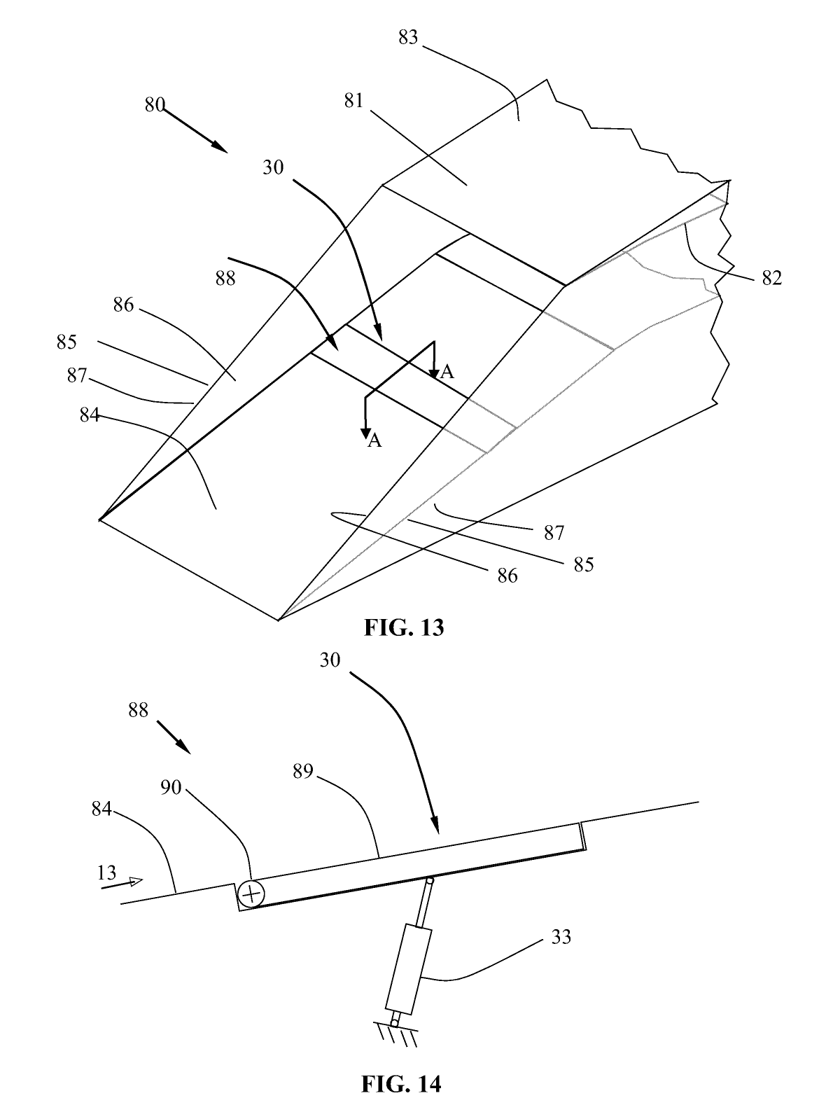

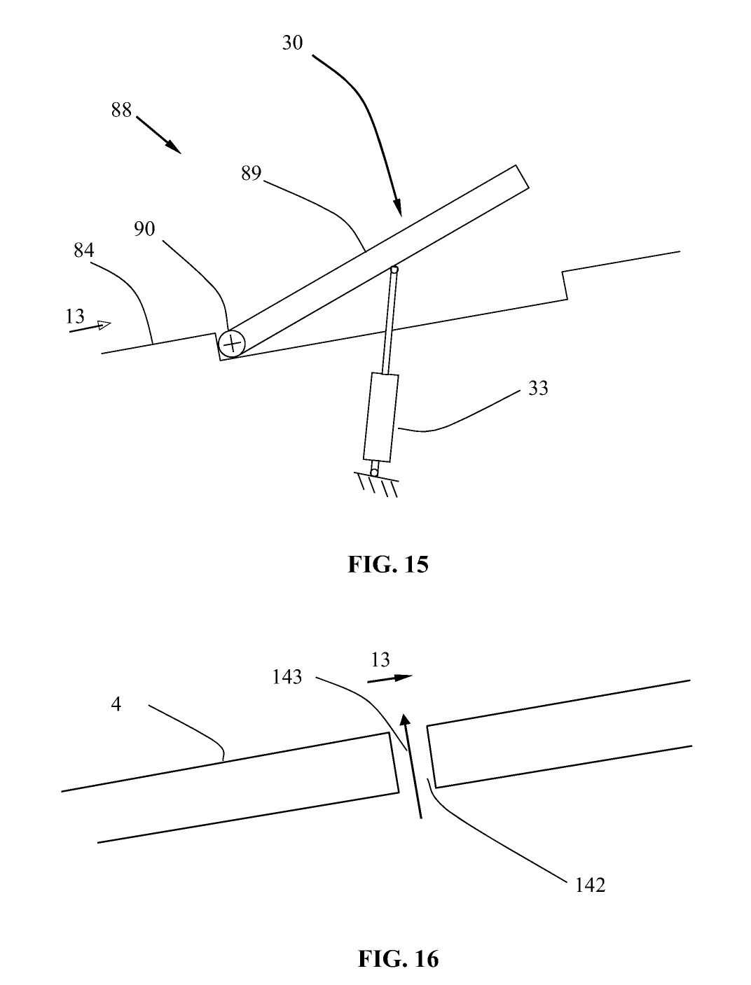

FIGS. 13-15 illustrate installation of an airflow-separation actuator system 30 in an embodiment of the present invention including a 2D supersonic inlet 80. With reference to FIG. 13, the 2D inlet 80 includes a cowl 81 having an internal surface 82 and an external surface 83, a ramp surface 84 and sidewalls 85 with an internal surface 86 and an external surface 87. An airflow-separation actuator door 88 is installed into the ramp surface 84. For the 2D inlet 80 illustrated in FIG. 13, the quick airflow-separation actuator restart system 88 includes a single door 89 (see FIG. 14). FIGS. 14 and 15 illustrate a cross-sectional view of the door 88 in the 2D inlet 80 (see FIG. 13). In the illustrated embodiment, the cross-sectional shape of the door 88 in the 2D inlet 80 (see section A-A of FIG. 13) is substantially rectangular, and is similar to the cross-sectional shape of the door 31 in FIGS. 11 and 12 for the axisymmetric inlet 1 (see FIGS. 11 and 12). As illustrated, the actuated surface 89 of the airflow separation actuator 88 is a single surface (and the incoming airflow flows along that surface). However other embodiments, in which the actuated surface 89 is divided into a plurality of actuated surfaces covering the same width of the ramp surface 84 (similar to the embodiment illustrated in FIG. 10 in which the plurality of flaps 31 cover the entire circumference of the external surface 4 of the centerbody 2) are also contemplated.

The variation in the inlet aerodynamics during an unstarted operating condition has been shown to be effected by adjustment of airflow separation actuator doors 31, 89 (see FIGS. 6 and 14, respectively). Alternate methods of achieving the same controlling separation region 26 achieved in FIG. 6 are depicted in FIGS. 16-20.

With reference to FIGS. 16-18, an alternate embodiment is illustrated for creating a variation in the inlet aerodynamics during an unstarted operating condition. As illustrated in FIG. 16, an opening 142 in the external surface 4 is provided to allow a blowing airflow 143 to exit the surface 4 into the local inlet airflow 13. Regulation of the blowing airflow 143, weight flow, and pressure can effect a similar separated airflow control as provided by the airflow separation actuator doors 31, 89 (see FIGS. 6 and 14, respectively). Although the blowing opening 142 is illustrated as a single hole, it is also contemplated that the opening in the inlet surface 4 is a series of holes or a slot. The opening 142 may allow blowing airflow 143 to exit normal to the surface 4, as illustrated in FIG. 16, or may be located at an angle to the surface 4.

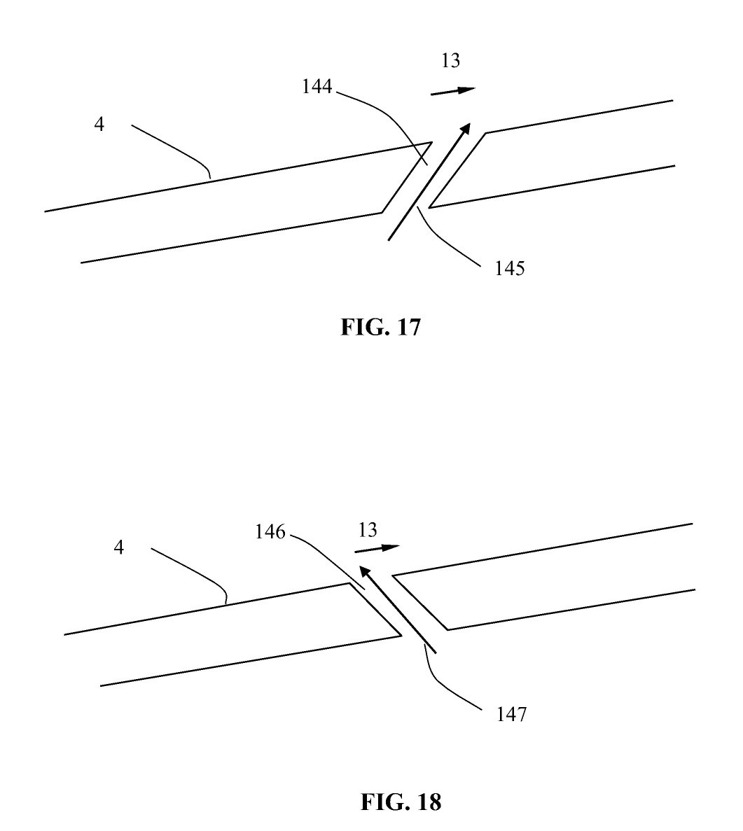

With reference to FIG. 17, an angled opening 144 is used to exhaust the exiting airflow 145 at a downstream angle with respect to the local airflow 13. With reference to FIG. 18, an angled opening 146 is used to exhaust the exiting airflow 147 at an upstream angle with respect to the local airflow 13. As discussed above, it is contemplated that the openings 142, 144, 146 in FIGS. 16-18 may be series of adjacent holes or a slot in the local inlet surface.

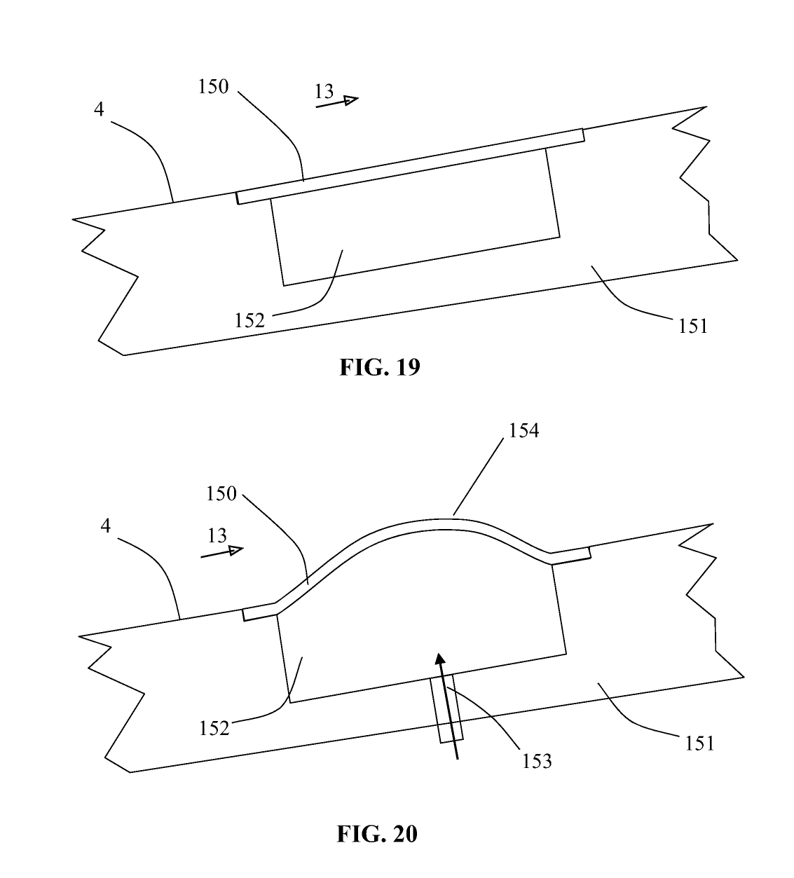

With reference to FIGS. 19 and 20, the separation actuation may also be initiated by creating a bump or bulge on the inlet surface. An example of a bump or bulge is illustrated in FIGS. 19 and 20. A flexible material 150 is recessed into the inlet surface 4. A plenum 152 is formed between an inlet part 151 and the flexible material 150. The means of actuating the material 150 would be located in this plenum 152. For example, in the illustrated embodiment, actuation of the flexible material 150 may be achieved by pumping a fluid (e.g., air or liquid) into the plenum 152. Alternatively, actuation of the flexible material may be achieved by a mechanical actuator. Actuation of the material 150 by pressurized airflow 153 is illustrated in FIG. 20. A bump 154 (bulge) of the flexible material 150 with respect to the inlet surface 4, which results from introduction of the fluid 153 into the plenum 152, creates a disruption to the local airflow 13 (similar to the airflow disruption discussed above when the a door 30 of FIG. 6 is actuated).

The embodiments of the present invention discussed above relate to an inlet system of a high-speed flight vehicle. A unique airflow-separation actuator concept effects quick restart of a high-speed, mixed-compression inlet. Alternately, the airflow-separation actuator may also be utilized to provide an increased stable range (buzz-free) for unstarted inlet operation.

The different embodiments of the airflow-separation actuators discussed above provide light weight (with reduced complexity over conventional) methods of restarting an inlet.

It is also contemplated that the airflow-separation actuators discussed above may be utilized to extend the range of stable unstarted inlet operation on either commercial or military aircraft.

Although the airflow-separation actuators discussed above have been illustrated for use on propulsion systems of a supersonic aircraft, it is also contemplated that such actuators be used on hypersonic (and other) aircraft or missile.

Other actuators for disrupting the local airflow and creating a controlled separation of the airflow to enhance inlet starting as discussed above are also contemplated.

In addition to the embodiments discussed above, it will be evident to those skilled in the art that the concepts of the present invention may be extended to the design of other mixed-compression inlet types (e.g., 3-dimensional inlets).

While the examples depicting the integration of the invention concept are presented, it will be evident to those skilled in the art that the concept may be extended to the design of other mixed-compression inlet types such as 3-dimensional inlets.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/We claim:

1. A supersonic inlet, comprising:
a cowl;
an innerbody;
an airflow duct entrance, between the cowl and the centerbody, receiving an incoming airflow;
an airflow duct exit, between the cowl and the centerbody, delivering a subsonic airflow; and
a controlled airflow separation initiator, on the innerbody and upstream of a lip of the cowl, which, when actuated, creates a separation in the incoming airflow, the separation changing local flow field aerodynamics such that an airflow weight flow at the cowl lip matches an airflow weight flow at a duct minimum area, between the airflow duct entrance and the airflow duct exit.

2. The supersonic inlet as set forth in claim 1, wherein:
the innerbody is a centerbody having a substantially round cross-section; and
the incoming airflow flows along a surface of the innerbody.

3. The supersonic inlet as set forth in claim 2, wherein the controlled airflow separator initiator comprises:
a plurality of flaps, around a circumference of the centerbody, that extend into the incoming airflow when the controlled airflow separation initiator is actuated.

4. The supersonic inlet as set forth in claim 1, wherein the controlled airflow separator initiator comprises:
the innerbody has a substantially rectangular cross-section; and
the incoming airflow flows along one surface of the innerbody.

5. The supersonic inlet as set forth in claim 1, wherein the matching airflow weight flows facilitates restart of the inlet.

6. The supersonic inlet as set forth in claim 1, wherein the controlled airflow separator initiator comprises:
a barrier that extends into the incoming airflow when the controlled airflow separation initiator is actuated.

7. The supersonic inlet as set forth in claim 6, wherein:
the barrier is a flap pivoting around a hinge.

8. The supersonic inlet as set forth in claim 6, wherein:
the barrier is a substantially normal to a surface of the innerbody.

9. The supersonic inlet as set forth in claim 1, wherein the controlled airflow separator initiator comprises:
an airflow passage in the innerbody passing a blowing airflow into the incoming airflow, the blowing airflow creating an increased relatively higher pressure airflow downstream of the cowl lip.

10. The supersonic inlet as set forth in claim 9, wherein:
the airflow passage is angled to pass the blowing airflow into the incoming airflow at an angle other than 90° .

11. The supersonic inlet as set forth in claim 1, wherein:
when the controlled airflow separator initiator is actuated, a first volume of a relatively higher pressure airflow downstream of the cowl lip is increased.

12. The supersonic inlet as set forth in claim 11, wherein when the controlled airflow separator initiator is actuated:
a second volume of a relatively lower pressure airflow downstream of the cowl lip is decreased; and
a majority of the airflow downstream of the controlled airflow separator initiator flows in the first volume of the relatively higher pressure airflow.

13. The supersonic inlet as set forth in claim 12, wherein:
a leading edge of an airflow separation region extends from a downstream edge of the controlled airflow separator initiator.

14. The supersonic inlet as set forth in claim 1, wherein the controlled airflow separator initiator comprises:
a plenum in the innerbody; and
a flexible material over the plenum, a pressure in the plenum increasing and causing the flexible material to expand into the incoming airflow when the controlled airflow separation initiator is actuated.

15. The supersonic inlet as set forth in claim 1, wherein:
an oblique shock wave emanating from a leading edge of the separation is moved upstream of the cowl lip when the controlled airflow separation initiator is actuated.

16. The supersonic inlet as set forth in claim 1, wherein:
the separation reduces an effective area between the cowl lip and the effective inner boundary.

17. A supersonic inlet, comprising:
a cowl;
an innerbody;
an airflow duct entrance, between the cowl and the centerbody, receiving an incoming airflow;
an airflow duct exit, between the cowl and the centerbody, delivering a subsonic airflow; and
a controlled airflow separation initiator, on the innerbody and upstream of a lip of the cowl, creating a controlled separation that causes an airflow weight flow at the cowl lip to match an airflow weight flow at a duct minimum area, between the airflow duct entrance and the airflow duct exit, when the controlled airflow separation initiator is actuated.

18. A method of restarting an unstarted supersonic inlet, the method comprising:
passing an incoming airflow into an airflow duct entrance;
matching an airflow weight flow at the cowl lip with an airflow weight flow at a duct minimum area, between the airflow duct entrance and an airflow duct exit; and
restarting the supersonic inlet.

19. The method of restarting an unstarted supersonic inlet as set forth in claim 18, wherein the matching step includes:
activating a controlled airflow separation initiator on the innerbody and upstream of a lip of the cowl.

20. The method of restarting an unstarted supersonic inlet as set forth in claim 18, further including:
extending a flap into the incoming airflow.

21. The method of restarting an unstarted supersonic inlet as set forth in claim 18, further including:
passing a blowing airflow into the incoming airflow.

22. The method of restarting an unstarted supersonic inlet as set forth in claim 18, further including:
introducing a fluid into a plenum to expand a flexible material into the incoming airflow.

23. The method of restarting an unstarted supersonic inlet as set forth in claim 18, further including:
creating an increased relatively higher pressure airflow downstream of the cowl lip.
